(19) United States
(12) Patent Application Publication
(10) Pub. No.: US 2021/0104774 A1
(43) Pub. Date: Apr. 8, 2021

(54) SOLID-STATE BATTERY AND METHOD FOR PRODUCING SOLID-STATE BATTERY

(71) Applicant: HONDA MOTOR CO., LTD., Tokyo (JP)

(72) Inventors: Noriaki KAMAYA, Saitama (JP); Hiroto MAEYAMA, Saitama (JP); Ushio HARADA, Saitama (JP); Sokichi OKUBO, Saitama (JP); Toru SUKIGARA, Saitama (JP)

(21) Appl. No.: 16/965,014

(22) PCT Filed: Jan. 31, 2019
(86) PCT No.: PCT/JP2019/003309

§ 371 Date: Jul. 27, 2020

(30) Foreign Application Priority Data
Feb. 1, 2018 (JP) 2018-016548
Feb. 1, 2018 (JP) 2018-016551

(51) Int. Cl. H01M 10/0562; H01M 4/40; H01M 4/46; H01M 4/134; H01M 10/0585

(52) U.S. Cl. CPC H01M 10/0562; H01M 4/405; H01M 10/0585; H01M 4/134; H01M 4/463

(57) ABSTRACT

The present invention provides: a solid-state battery which is not susceptible to decrease of the discharging capacity even if charge and discharge are repeated; and a method for producing a solid-state battery, which enables the achievement of a good bonded interface between a solid electrolyte layer and a anode layer by a simple process.

A solid-state battery 1 according to the present invention is provided with a cathode layer 20, a anode layer 30 and a solid electrolyte layer 40 that is arranged between the cathode layer 20 and the anode layer 30. The anode layer 30 is provided with an aluminum layer 31 that is in contact with the solid electrolyte layer 40, a lithium layer 32, and an aluminum-lithium alloy layer 33 that is arranged between the aluminum layer 31 and the lithium layer 32.

This application is based on and claims the benefit of priority from Japanese Patent Application No. 2018-016548, filed on 1 Feb. 2018, and Japanese Patent Application No. 2018-016551, filed on 1 Feb. 2018, the content of which is incorporated herein by reference.

### TECHNICAL FIELD

The present invention relates to a solid-state battery comprising a cathode electrode layer, an anode electrode layer and a solid electrolyte layer and a method for producing the solid-state battery.

### BACKGROUND ART

Conventionally, anodes containing an aluminum-lithium alloy are considered to have a high capacity, but when the anodes are used in a lithium ion battery using a general organic solvent, the lithium-ion battery is considered to have a low durability because LiAl is ionized and eluted into the solvent or is micronized by repetition of charge and discharge (see, for example, Non-Patent Document 1).

Therefore, even if an aluminum-lithium alloy is used as an anode of a lithium-ion battery, it was difficult to take advantage of intrinsic characteristics of the aluminum-lithium alloy.

On the other hand, the aluminum-lithium alloy is expected as a material for an anode of a solid-state battery using no organic solvents or the like.

For example, a technique has been proposed in which an anode electrode layer of a solid-state battery is formed by press molding a sulfide-based solid electrolyte material and a powdery aluminum-lithium alloy (see, for example, Patent Document 1).

Further, as a method of manufacturing a solid-state battery, a method of assembling a solid-state battery by stacking and joining the constituent layers of the solid-state battery has been proposed (see, for example, Patent Document 2).

Patent Document 1: Japanese Unexamined Patent Application, Publication No. 2014-154267

Patent Document 2: Japanese Unexamined Patent Application, Publication No. 2012-256436

### Non-Patent Document

Non-Patent Document 1: L. Y. Beaulieu et al., “Colossal Reversible Volume Changes in Lithium Alloys”, Electrochemical and Solid-State Letters, 4(9), A137-A140 (2001)

### DISCLOSURE OF THE INVENTION

### Problems to be Solved by the Invention

However, in an anode electrode layer using a powdery aluminum-lithium alloy, repetition of charge and discharge results in declination in discharging capacity.

In addition, a solid-state battery comprising an anode electrode layer formed of a powdery aluminum-lithium alloy and a solid electrolyte has the possibility that application of a solid electrolyte material on the anode electrode layer in a step of assembling the solid-state battery results in exfoliation at an interface between the solid electrolyte layer and the anode electrode layer and this results in deterioration of the performance of the solid-state battery. Therefore, a step of applying two or more layers of a solid electrolyte material (two-layer application) on the anode electrode layer was required, making the manufacturing process complicated.

It is an object of the present invention to provide a solid-state battery in which the discharging capacity does not easily decline even after repeated charging and discharging. It is also an object of the present invention to provide a method for producing a solid-state battery in which a good junction interface between the solid electrolyte layer and the anode electrode layer is obtained by a simple process.

### Means for Solving the Problems

A first aspect of the present invention relates to a solid-state battery comprising a cathode electrode layer, an anode electrode layer, and a solid electrolyte layer disposed between the cathode electrode layer and the anode electrode layer, in which the anode electrode layer comprises an aluminum layer in contact with the solid electrolyte layer, a lithium layer and an aluminum-lithium alloy layer disposed between the aluminum layer and the lithium layer.

A second aspect of the present invention relates to the solid-state battery as described in the first aspect, in which the film thickness of the anode electrode layer may be 10 to 400 μm.

A third aspect of the present invention relates to the solid-state battery as described in the first or second aspect, in which a molar ratio of lithium to aluminum, Li:Al, in the anode electrode layer may be 30:70 to 80:20.

A fourth aspect of the present invention relates to the solid-state battery as described in any one of the first to third aspects, in which the solid electrolyte layer may be a sulfide-based solid electrolyte material.

A fifth aspect of the present invention relates to a method for manufacturing a solid-state battery comprising a cathode electrode layer, an anode electrode layer comprising an aluminum layer and a lithium layer, and a solid electrolyte layer disposed between the cathode electrode layer and the anode electrode layer,
the method comprising: a step of applying a solid electrolyte material to an aluminum plate for forming the aluminum layer to form the solid electrolyte layer; and a step of press joining a laminate to obtain the solid-state battery, with the laminate being obtained by disposing the cathode electrode layer on the solid electrolyte layer formed on one surface of the aluminum plate, and disposing a lithium plate for forming the lithium layer on the other surface of the aluminum plate on which the solid electrolyte layer is not formed.

A sixth aspect of the present invention relates to the method for manufacturing a solid-state battery as described in the fifth aspect, in which the method may further comprise a step of cutting the press joined solid-state battery to a predetermined length under compression.

A seventh aspect of the present invention relates to the method for manufacturing a solid-state battery as described in the fifth or sixth aspect, in which the step of press joining may be performed by a roll pressing method.

### Effects of the Invention

(1) The solid-state battery of the present invention comprises a cathode electrode layer, an anode electrode layer, and a solid electrolyte layer disposed between the cathode electrode layer and the anode electrode layer, with the anode electrode layer comprising an aluminum layer in contact with the solid electrolyte layer, a lithium layer, and an aluminum-lithium alloy layer disposed between the aluminum layer and the lithium layer.

Since the aluminum layer which constitutes the anode electrode layer contacts with the solid electrolyte layer, when the solid-state battery is discharged, lithium in the lithium layer moves toward the solid electrolyte side, but the lithium forms an alloy with aluminum in the aluminum layer before reaching the solid electrolyte layer. This can prevent lithium from flowing out from the solid electrolyte layer side due to discharging.

Even when the solid-state battery is repeatedly charged and discharged, formation of alloy of aluminum and lithium proceeds, and thereby decrease in aluminum from the anode electrode layer can be suppressed.

This enables provision of a solid-state battery in which the discharging capacity does not easily decline even if charge and discharge is repeated.

(2) In the solid-state battery as described in the first aspect, the anode electrode layer has a suitable film thickness of 10 to 400 μm, and this can suppress charge and discharge from decreasing aluminum and lithium from the anode electrode layer.

Thereby, it is possible to provide a solid-state battery in which the discharging capacity does not easily decline even after repeated charging and discharging.

(3) In the solid-state battery as described in the first or second aspect, a molar ratio of lithium and aluminum, Li:Al, in the anode electrode layer is 30:70 to 80:20, and this suppresses charge and discharge from forming an α-LiAl phase, in which aluminum is excessive or a monophase of lithium in the aluminum-lithium alloy, and thereby an aluminum-lithium alloy layer with an appropriate blending ratio can be formed. Thus, it is possible to provide a solid-state battery in which the discharging capacity does not easily decline even after repeated charging and discharging.

(4) In the solid-state battery as described in any one of the first to third aspects, the solid electrolyte layer is a sulfide-based solid electrolyte material, and thereby the aluminum-lithium alloy is not ionized to a solid electrolyte nor is eluted, unlike a lithium ion battery which uses an organic solvent and in which an aluminum-lithium alloy is used as the anode. Thereby, high durability can be maintained.

Thus, it is possible to provide a sulfide-based solid-state battery, in which the discharging capacity does not easily decline even after repeated charging and discharging.

(5) The method for manufacturing a solid-state battery, which is another aspect of the present invention, comprises: a step of applying a solid electrolyte material to an aluminum plate for forming an aluminum layer to form a solid electrolyte layer; and a step of press joining a laminate to obtain the solid-state battery, with the laminate being obtained by disposing a cathode electrode layer on the solid electrolyte layer formed on one surface of the aluminum plate, and disposing a lithium plate for forming a lithium layer on the other surface of the aluminum plate on which the solid electrolyte layer is not formed. Thereby, the solid electrolyte material is directly applied to the aluminum plate which constitutes the anode electrode layer, and this enables obtainment of a good junction interface between the solid electrolyte layer and the anode electrode layer.

Further, the solid electrolyte material in a state of being directly applied on the aluminum plate is press joined at once together with the lithium plate and the cathode electrode layer to obtain the solid-state battery.

Therefore, according to the fifth aspect, a step of directly applying a solid electrolyte layer to an anode electrode layer (or a cathode electrode layer) comprising a powdery active material and a solid electrolyte itself does not exist nor is a step of re-application of an anode which has been already coated (two-layer application) necessary.

Therefore, it is possible to manufacture a solid-state battery having a good junction interface between the solid electrolyte layer and the anode electrode layer by a simple and convenient process.

(6) Since the method for manufacturing a solid-state battery as described in the fifth aspect further comprises a step of cutting the press joined solid-state battery to a manufacture a solid-state battery having a good junction interface between the solid electrolyte layer and the anode electrode layer.

(7) In the method for manufacturing a solid-state battery as described in the fifth or sixth aspect, the step of press joining is performed by a roll pressing method. Thereby, it is possible to manufacture a solid-state battery having a good junction interface between the solid electrolyte layer and the anode electrode layer by a simple and convenient press joining method.

### BRIEF DESCRIPTION OF THE DRAWINGS

FIG. 1 is an explanatory view illustrating a cross section of a solid-state battery according to one embodiment of the present invention;

FIG. 2 is a drawing showing discharging capacity retention rates of Example 1 and Comparative Example 1 for each cycle;

FIG. 3 is a drawing showing changes in DCR resistances of Example 1 and Comparative Example 1 for each cycle;

FIG. 4 is an X-ray diffraction spectra of Example 1 before and after a cycle test;

FIG. 5 is an X-ray diffraction spectra of Comparative Example 1 before and after a cycle test.

FIG. 6 is a drawing showing changes in discharging capacity retention rates of Examples 2 to 6 for each cycle;

FIG. 7 is a phase diagram of an aluminum-lithium alloy of a two-component system;

FIG. 8 is an explanatory view illustrating a method for manufacturing the solid-state battery according to an embodiment of the present invention;

FIG. 9 is an explanatory view illustrating an example of the cutting step in the method for manufacturing a solid-state battery according to one embodiment of the present invention;

FIG. 10 is a cross-sectional SEM image of the solid-state battery of Example 1 after charge and discharge of 100 cycles; and

FIG. 11 is a cross-sectional SEM image of the solid-state battery of Comparative Example 1 after charge and discharge of 100 cycles.

### PREFERRED MODE FOR CARRYING OUT THE INVENTION

<Solid-State Battery>

Hereinafter, one embodiment of the solid-state battery of the present invention will be described in detail, with reference to drawings.

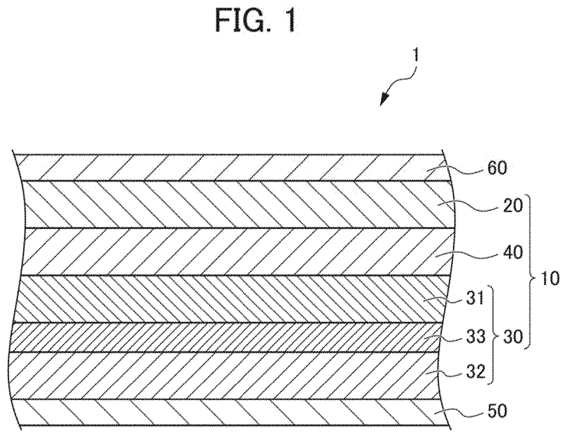

FIG. 1 is an explanation drawing showing a cross section of the solid-state battery according to one embodiment of the present invention.

As indicated in FIG. 1, a solid-state battery 1 comprises a battery body 10, an anode current collector 50 and a cathode current collector 60.

Note that, in the present specification, the solid-state battery refers to a battery all of which is solidified.

The anode current collector 50 and the cathode current collector 60 are conductive plate-like members that hold the battery body 10 from both sides.

The anode current collector 50 has function of collecting current of an anode electrode layer 30 and the cathode current collector 60 has function of collecting current of a cathode electrode layer 20.

Electrode current collector materials to be used in the anode current collector 50 are not particularly limited and any conductive material can be used. Examples include copper, nickel, stainless steel, vanadium, manganese, iron, titanium, cobalt, zinc, etc., and among them, copper and nickel are preferable, because they have excellent conductivity and excellent current collecting properties.

A shape and thickness of the anode current collector 50 are not particularly limited so far as the shape and thickness are within an extent that allows the anode electrode layer 30 to collect current.

Examples of the electrode current collector materials to be used in the cathode current collector 60 include vanadium, aluminum, stainless steel, gold, platinum, manganese, iron, titanium, etc. and among them, aluminum is preferred.

A shape and thickness of the cathode current collector 60 are not particularly limited so far as the shape and thickness are within an extent that allows the cathode electrode layer 20 to collect current.

The battery body 10 comprises a cathode electrode layer 20 functioning as a cathode, an anode electrode layer 30 functioning as an anode, and a conductive solid electrolyte layer 40 located between the cathode electrode layer 20 and the anode electrode layer 30.

The anode electrode layer 30 has an aluminum layer 31, a lithium layer 32 and an aluminum-lithium alloy layer 33 disposed between the aluminum layer 31 and the lithium plate 32.

The cathode electrode layer 20 is disposed on a solid electrolyte layer 40 formed on one surface of the aluminum layer 31 in the press joining step, which is to be explained below.

In the present embodiment, the cathode electrode layer 20 is formed by press molding a material containing a cathode active material and a sulfide-based solid electrolyte.

Examples of the cathode active material include layered cathode active materials such as LiCoO2, LiNiO2, LiCo1/3Ni1/3Mn1/3O2, LiVO2, LiCrO2, etc.; spinel type cathode active materials such as LiMn2O4, Li(Ni0.25Mn0.75)2O4, LiCoMnO4, Li2NiMn3O8, etc.; and olivine type cathode active materials such as LiCoPO4, LiMnPO4, LiFePO4, etc.

The sulfide-based solid electrolyte material used in the cathode electrode layer 20 typically contains metal element (M), which becomes conducting ions, and sulfur (S).

Examples of the M include Li, Na, K, Mg, Ca, etc. and among others, Li is preferred.

In particular, the sulfide-based solid electrolyte material preferably comprises Li, A (A is at least one selected from the group consisting of P, Si, Ge, Al and B) and S.

Moreover, the A is preferably P (phosphorus).

Further, the sulfide-based solid electrolyte material may include halogen such as Cl, Br, I, etc.

This is because inclusion of halogen improves ion conductivity. The sulfide-based solid electrolyte material may comprise O.

Examples of the sulfide-based solid electrode material having Li ion conductivity include, Li2S-P2S5, Li2S-P2S5-LiI, Li2S-P2S5-Li2O, Li2S-P2S5-Li2O-LiI, Li2S-SiS2, Li2S-SiS2-LiI, Li2S-SiS2-LiBr, Li2S-SiS2-LiCl, Li2S-SiS2-B2S3-LiI, Li2S-SiS2-P2S5-LiI, Li2S-B2S3, Li2S-P2S5-ZmSn (provided that m and n are positive numbers; Z is any one of Ge, Zn and Ga), Li2S-GeS2, Li2S-SiS2-Li3PO4, Li2S-SiS2-LixMOy (provided that x and y are positive numbers; M is any one of P, Si, Ge, B, Al, Ga and In), etc.

Note that the recitation “Li2S-P2S5” refers to a sulfide-based solid electrolyte material formed by using a raw material composition comprising Li2S and P2S5 and this applies to other recitations.

Further, when the sulfide-based solid electrolyte material is one formed by using a raw material composition comprising Li2S and P2S5, a ratio of Li2S with respect to a total of Li2S and P2S5 is preferably within a range of, for example, 70 mol % to 80 mol %, more preferably 72 mol % to 78 mol %, and most preferably 74 mol % to 76 mol %.

This is because such a range allows the sulfide-based solid electrolyte material to have an ortho composition or a composition close thereto, allowing the sulfide-based solid electrolyte material to be chemically stable.

In this regard, the term “ortho” generally refers to an oxo acid having the highest degree of hydration in different oxo acids obtained by hydrating a single oxide.

In the present embodiment, a crystal composition of a sulfide to which the largest amount of Li2S is added is referred to an ortho composition.

In a Li2S-P2S5 system, Li3PS4 corresponds to the ortho composition.

In a case in which the solid electrolyte material is a Li2S-P2S5-based sulfide-based solid electrolyte material, a ratio of Li2S and P2S5, Li2S:P2S5, for obtaining the ortho composition is 75:25 on a molar basis.

Note that when Al2S2 or B2S3 is used instead of P2S5 in the above-mentioned raw material composition, a preferred range is as described above.

In Li2S-Al2S3 and Li2S-B2S3 systems, Li3AlS3 and Li3BS3 correspond to the ortho compositions, respectively.

In addition, when the sulfide-based solid electrolyte material is formed by using a raw material composition containing Li2S and SiS2, a ratio of Li2S to a total of Li2S and SiS2 is preferably within a range of, for example, 60 mol % to 72 mol %, more preferably within a range of 62 mol % to 70 mol %, and most preferably within a range of 64 mol % to 68 mol %. This is because such a range allows the sulfide-based solid electrolyte material to have an ortho composition or a composition close thereto, allowing the sulfide-based solid electrolyte material to be chemically stable.

In a Li2S-SiS2 system, Li4SiS4 corresponds to the ortho composition.

In a case of Li2S-SiS2-based sulfide-based solid electrolyte materials, a ratio of Li2S and SiS2, Li2S:SiS2, for obtaining an ortho composition is 66.6:33.3 on a molar basis.

Note that when GeS2 is used instead of SiS2 in the above-mentioned raw material composition, the preferred range is as described above.

In Li2S-GeS2 system, Li4GeS4 corresponds to the ortho-composition.

In addition, when the sulfide-based solid electrolyte material is formed by using a raw material composition containing LiX (X=Cl, Br, I), a ratio of LiX is preferably within a range of, for example, 1 mol % to 60 mol %, more preferably within a range of 5 mol % to 50 mol %, and most preferably within a range of 10 mol % to 40 mol %.

Further, the sulfide-based solid electrolyte material may be a sulfide glass, a crystallized sulfide glass, or a crystalline material obtained by a solid phase method.

Note that the sulfide glass can be obtained, for example, by mechanically milling (ball milling or the like) a raw material composition.

Further, the crystallized sulfide glass can be obtained, for example, by subjecting a sulfide glass to a heat treatment at temperatures higher than or equal to the crystallization temperature.

In addition, when the sulfide-based solid electrolyte material is a Li ion conductor, the Li ion conductivity at room temperature is preferably, for example, 61×10−5 S/cm or more, and more preferably 1×10−4 S/cm or more.

In addition to the above-described sulfide-based solid electrolyte and cathode active material, the cathode electrode layer 20 may contain a conductivity-imparting material, a binder and a solid electrolyte.

The anode electrode layer 30 in this embodiment is a member comprising the aluminum layer 31 in contact with the solid electrolyte layer 40, the lithium layer 32 in contact with the anode current collector 50, and the aluminum-lithium alloy layer 33 disposed between the aluminum layer 31 and the lithium layer 32.

The aluminum layer 31 is a layer comprising aluminum as a main component.

The lithium layer 32 is a plate-like, foil-like or thin film-like layer containing lithium as a main component.

The aluminum-lithium alloy layer 33 is a plate-like, foil-like or thin film-like layer which is formed when the solid-state battery 1 is charged, when the solid-state battery 1 is discharged, when aluminum and lithium are press molded, or when the solid-state battery 1 is manufactured by a joining step to be described below, or the like.

Incidentally, in this specification, the aluminum-lithium alloy layer 33 is not limited to a layer comprising an aluminum-lithium alloy as a main component, but also includes a portion serving as a starting point for forming an aluminum-lithium alloy.

In this embodiment, the anode electrode layer 30 consists of the aluminum layer 31, the lithium layer 32, and the aluminum-lithium alloy layer 33 alone.

The anode electrode layer 30 is formed by press molding, for example, a plate-like (foil-like, thin film-like) aluminum and lithium.

Thereby, the anode electrode layer 30 containing the aluminum layer 31, the lithium layer 32 and the aluminum-lithium alloy layer 33 is formed.

Note that the anode electrode layer 30 may be formed by vapor-depositing lithium to a plate-like (foil-like or thin film-like) aluminum by a sputtering method or the like.

The aluminum layer 31 is in contact with the solid electrolyte layer 40.

Here, when the solid-state battery 1 is discharged, lithium in the lithium layer 32 moves toward a solid electrolyte layer 40 side, but lithium is alloyed with aluminum in the aluminum layer 31 before reaching the solid electrolyte layer 40. Therefore, discharging makes it hard for lithium to flow out from the solid electrolyte layer 40 side.

On the other hand, the lithium layer 32 is in contact with the anode current collector 50.

For this reason, when the solid-state battery 1 is charged, aluminum in the aluminum layer 31 moves toward an anode current collector 50 side, but aluminum forms an alloy with lithium in the lithium layer 32 before reaching the anode current collector 50.

Therefore, charging makes it difficult for aluminum to flow out from the anode current collector 50 side.

Having the anode electrode layer 30 as described above promotes formation of an alloy of aluminum and lithium (allows the aluminum-lithium alloy layer 33 to grow), even when the solid-state battery 1 is repeatedly charged and discharged, and this can suppress aluminum and lithium from decreasing from the anode electrode layer 30.

Thus, it is possible to obtain a solid-state battery 1 in which the discharging capacity does not easily decline even after repeated charging and discharging. lithium alloy is used, aluminum is considered to decrease from an anode due to charge and discharge.

This phenomenon is considered to be due to outflow of aluminum from the anode current collector side by charging.

Therefore, if charge and discharge is repeated using a powdery aluminum-lithium alloy, the aluminum-lithium alloy is considered to be unable to exhibit intrinsic properties thereof, and to result in, for example, decrease in the discharging capacity.

Here, a film thickness of the anode electrode layer 30 is not particularly limited, but in this embodiment, the film thickness is 10 to 400 μm, and preferably 20 to 200 μm.

Further, at a stage prior to charge and discharge, the film thickness of the aluminum layer is, for example, 5 to 200 μm, and is preferably 10 to 100 μm.

Furthermore, at a stage prior to charge and discharge, a film thickness of a lithium layer is, for example, 5 to 200 μm, and is preferably 10 to 100 μm.

The film thickness of the anode electrode layer 30 coming to be included in an appropriate range makes it possible to further suppress charge and discharge from decreasing aluminum and lithium from the anode electrode layer 30.

Further, the film thickness of the aluminum layer 31 coming to be included in an appropriate range makes it possible to further suppress a decrease in lithium from the anode electrode layer 30 during discharging.

Furthermore, the film thickness of the lithium layer 32 coming to be included in an appropriate range makes it possible to further suppress a decrease in aluminum from the anode electrode layer 30 during charging.

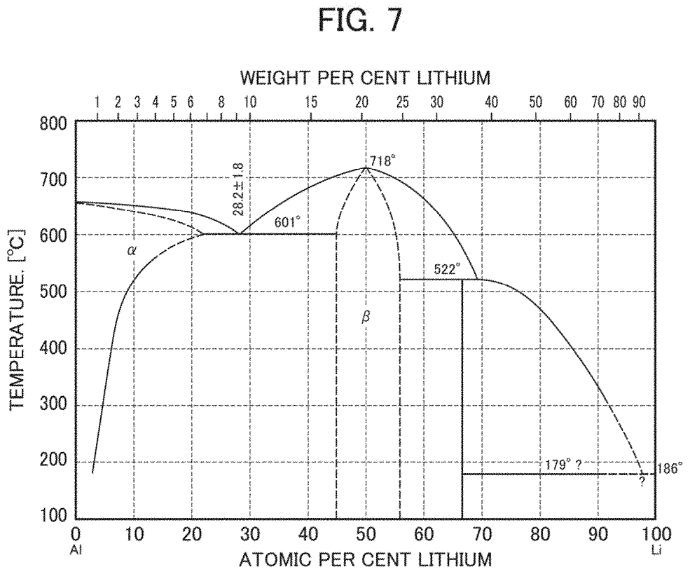

In addition, molar and mass ratios of lithium to aluminum in the anode electrode layer 30 are not particularly limited. In this embodiment, the molar ratio of lithium to aluminum, Li:Al, is 30:70 to 80:20, and preferably 35:65 to 50:50. Within this range, an α-LiAl phase, in which aluminum is excessive, or a monophase of lithium is not easily formed in the aluminum-lithium alloy by charge and discharge (see FIG. 7), and thereby an aluminum-lithium alloy layer 33 with an appropriate blending ratio can be formed.

The solid electrolyte layer 40 is formed by applying a solid electrolyte material on an aluminum plate for forming the aluminum layer 31 in a step of applying a solid electrolyte material to be described below.

In this embodiment, the solid electrolyte layer 40 is a plate-like member formed of a sulfide-based solid electrolyte material.

The sulfide-based solid electrolyte material is not particularly limited, but the same materials as the sulfide-based solid electrolyte materials for use in the cathode electrode layer 20 can be used.

<Method for producing Solid-State Battery>

Subsequently, a method for manufacturing the solid-state battery 1 according to an embodiment of the present invention will be described with reference to the drawings.

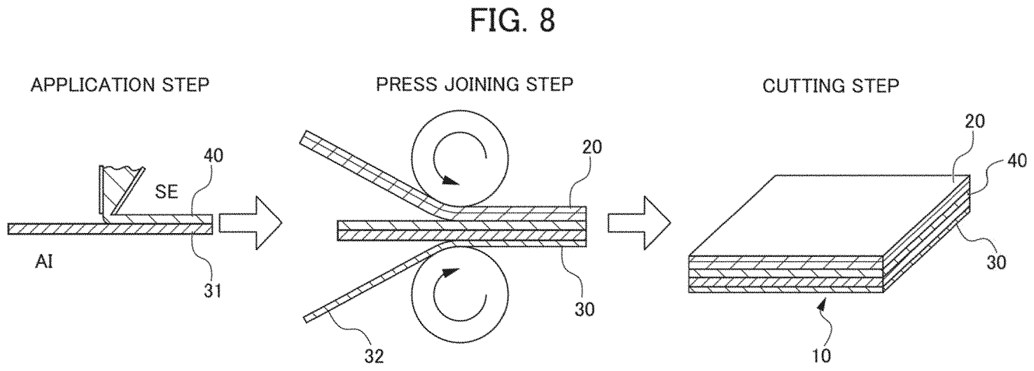

FIG. 8 is an explanatory view showing a method for manufacturing the solid-state battery according to an embodiment of the present invention; and

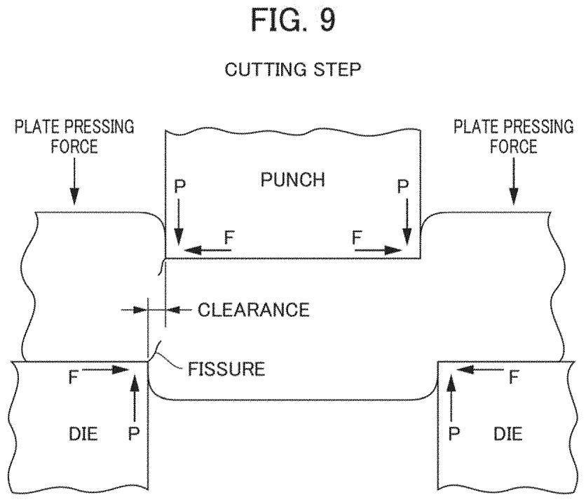

FIG. 9 is an explanatory view illustrating an example of the cutting step in the method for manufacturing a solid-state battery according to one embodiment of the present invention.

As shown in FIG. 8, the method for manufacturing the solid-state battery 1 comprises a solid electrolyte material application step, a press joining step and a cutting step.

[Solid Electrolyte Material Application Step]

The solid electrolyte material application step according to the present embodiment is a step of applying a solid electrolyte material on an aluminum plate for forming the aluminum layer 31, so as to form the solid electrolyte layer 40.

Examples of the method of applying a solid electrolyte material include a die coating method, a spray coating method, a transfer sheet method, a dip coating method, and a screen-printing method.

In the solid electrolyte material application step of the present invention, a solid electrolyte material is directly applied on an aluminum plate for forming the aluminum layer. Thus, the solid electrolyte material can be applied with high accuracy.

[Press Joining Step]

A press joining step according to the present embodiment is a step of obtaining the solid-state battery 1 by press joining a laminate: with the laminate being obtained by disposing the cathode electrode layer 20 on the solid electrolyte layer 40 formed on one surface of an aluminum plate for forming the aluminum layer 31, and disposing a lithium plate for forming the lithium layer 32 on the other surface of the aluminum plate on which the solid electrolyte layer 40 is not formed.

In this embodiment, the battery body 10 is press joined by the press joining step using a roll pressing method, with the solid electrolyte material being directly applied on the aluminum plate for forming the aluminum layer 31.

In the solid electrolyte material application step and the press joining step according to the present invention, a transfer sheet or the like of a solid electrolyte material is unnecessary, nor are two or more application steps of the solid electrolyte material necessary.

Thereby, a solid-state battery can be manufactured by a simple process.

Note that the press joining step can be carried out, for example, using a uniaxial pressing method, etc., instead of the roll pressing method.

[Cutting Step]

A cutting step is a step of cutting the press joined battery body to a predetermined length.

As shown in FIG. 9, in the present embodiment, the cutting step is a step of cutting the press joined battery body 10 to a predetermined length under compression.

In the present embodiment, as shown in FIG. 9, when a punch is lowered by applying a force P from above the die hole, a compression force is applied so that the battery body 10 is pressed down to the die.

Further, since there is a clearance so that the width of the die hole is longer than the width of the punch, a force F perpendicular to the force P arises from a contact between the battery body 10 and the punch and a contact between the battery body 10 and the peripheral portion of the die hole, and fissures are generated.

Therefore, continuous application of the force to the die hole from above develops fissures and the battery body 10 is cut to a predetermined length under compression.

In such a cutting step, no force is applied in the direction of peeling off respective constituents of the battery body 10. As a result, voids do not easily occur between the respective constituents of the battery body 10.

Further, since the battery body 10 is in a mechanism which is less likely to bend during cutting, the electrode position after punching is less likely to be displaced, and this facilitates lamination.

In this embodiment, as shown in FIG. 1, the battery body obtained by cutting is joined with the anode current collector 50 and the cathode current collector 60 to give the solid-state battery 1 comprising the anode current collector 50 and the cathode current collector 60.

Further, the solid-state battery 1 may be repeatedly charged and discharged.

The charge and discharge step advances alloying of aluminum and lithium (allows the aluminum-lithium alloy layer 33 to grow), and the solid-state battery 1 is obtained in which the discharging capacity does not easily decline even after repeated charging and discharging.

### EXAMPLES

Subsequently, the present invention will be described in further detail with reference to the Examples, but the present invention is not limited thereto.

### Example 1

An aluminum foil having a thickness of 100 μm and a lithium foil having a thickness of 100 μm were superposed to obtain an anode electrode layer of Example 1.

### <Comparative Example 1>

Aluminum-lithium alloy powder was press molded to obtain an anode electrode layer of Comparative Example 1.

Solid-state batteries each incorporating an anode of Example 1 or an anode of Comparative Example 1 were prepared and used as solid-state batteries for a cycle test.

These solid-state batteries were subjected to 20, 50 and 100 cycles of charge and discharge.

Also, before the charge and discharge and for each cycle, discharging capacity and DCR resistance were measured.

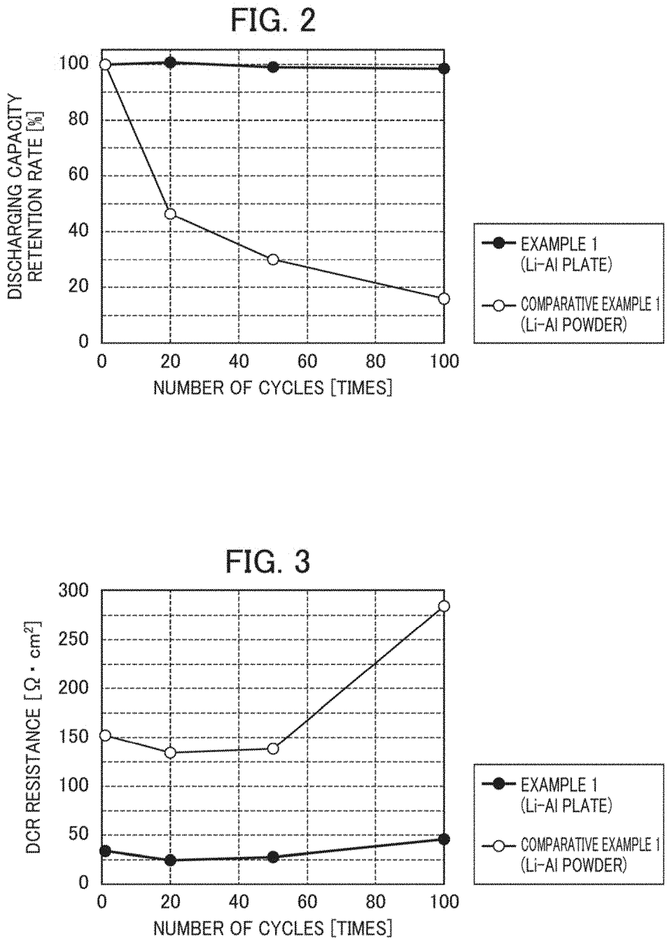

The results are shown in FIGS. 2 and 3.

Further, X-ray diffraction of the anode of Example 1 before the charge and discharge and the anode of Example 1 after 100 cycles of charge and discharge was performed from a cathode side (aluminum layer side).

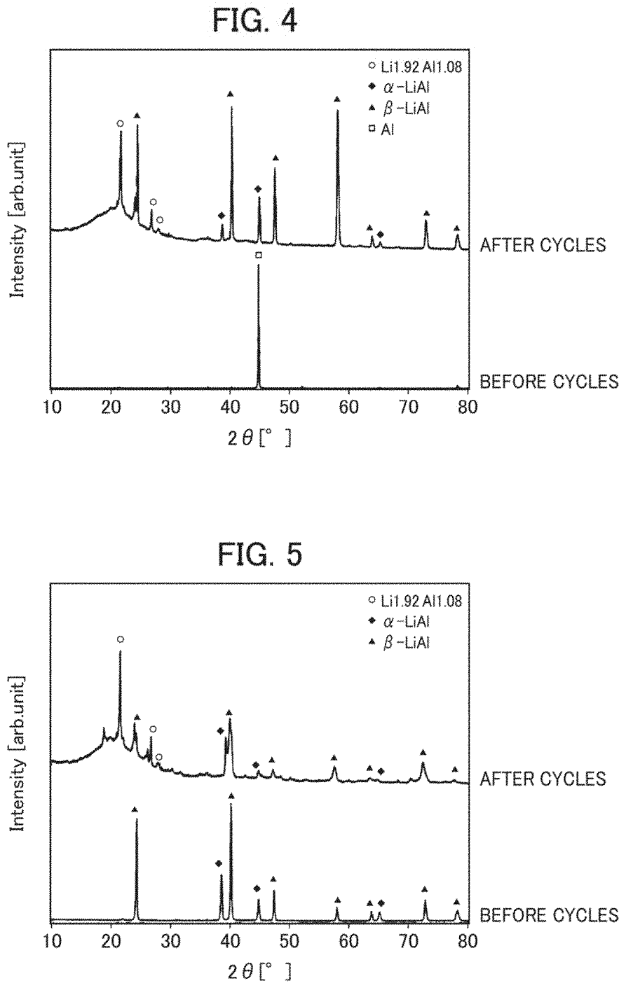

The results are shown in FIG. 4.

Similarly, X-ray diffraction of the anode of Comparative Example 1 after the charge and discharge and the anode of Comparative Example 1 after 100 cycles of charge and discharge was performed from the cathode side.

The results are shown in FIG. 5.

As shown in FIGS. 2 and 3, the solid-state battery of Example 1 using a plate-like (foil-like, thin film-like) anode electrode layer was confirmed to be more excellent than the solid-state battery using a powdery anode electrode layer in both the discharging capacity retention rate and the DCR-resistance in each cycle.

Further, as shown in FIG. 4, formation of an alloy has not progressed before repeating charge and discharge in the solid-state battery of Comparative Example 1 which comprises a plate-like anode electrode layer. An aluminum-lithium alloy layer with an appropriate blending ratio is considered to be formed as the charge and discharge is repeated.

In contrast, as shown in FIG. 5, in the solid-state battery comprising a powdery anode electrode layer, aluminum decreased from the anode electrode layer due to charge and discharge.

Specifically, it is considered that as charge and discharge is repeated, a layer containing a large amount of aluminum (α-LiAl phase, β-LiAl phase) decreased, and was transformed to a lithium- excessive Li1.92Al1.08 phase.

That is, since the present solid-state battery comprises an aluminum layer in contact with a solid electrolyte layer, and a lithium layer in contact with the aluminum layer, it is considered that an aluminum-lithium alloy layer with an appropriate blending ratio grows, as charge and discharge is repeated.

As a result, it is possible to provide a solid-state battery in which the discharging capacity does not easily decline even after repeated charging and discharging.

For the same reason, it is possible to provide a solid-state battery in which the DCR resistance does not easily increase even after repeated charging and discharging.

On the other hand, in the solid-state battery using a powdery anode electrode layer, aluminum decreased from the anode electrode layer after charge and discharge. This phenomenon is considered to be due to flow out of aluminum from the anode current collector side due to charging. Therefore, in the solid-state battery using a powdery anode electrode layer, the discharging capacity is considered to keep on declining, as charge and discharge are repeated. For the same reason, it is considered that the DCR-resistance will keep on increasing, as charge and discharge is repeated in the solid-state battery using a powdery anode electrode layer.

### Example 2 to Example 6

An aluminum plate and a lithium plate were superposed so that the content of lithium was:
38 mol % (Example 2),
44 mol % (Example 3),
50 mol % (Example 4),
60 mol % (Example 5) or,
80 mol % (Example 6), respectively, provided that the total of lithium and aluminum was assumed to be 100 mol %, to obtain anode electrode layers of Example 2 to Example 6.

Solid-state batteries incorporating the anode electrode layers of Example 2 to Example 6 were prepared in the same manner as in Example 1 to obtain solid-state batteries for cycle tests.

With respect to these solid-state batteries, charge and discharge of 1 to 100 cycles (1 to 20 cycles for Example 5 and Example 6) was performed.

Also, discharging capacity was measured before charge and discharge as well as for each cycle.

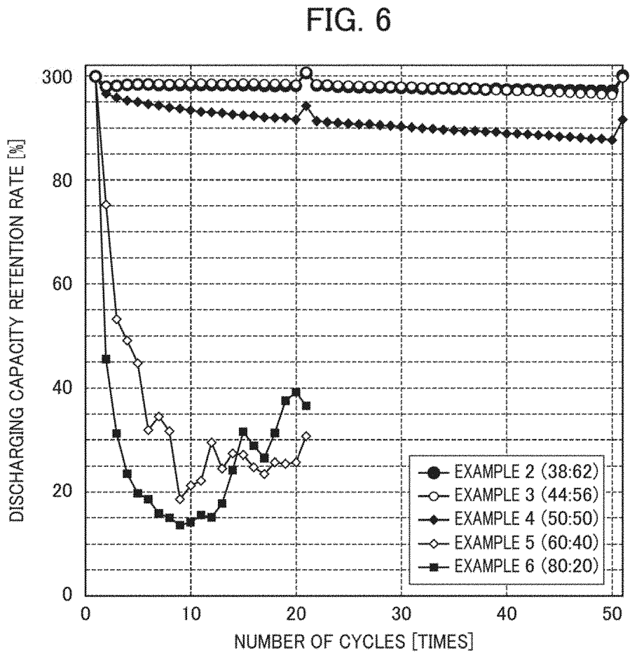

The results are given in FIG. 6.

The results shown in FIG. 6 will be discussed with reference to FIG. 7.

Here, FIG. 7 is a phase diagram of a two-component aluminum-lithium alloy.

According to FIG. 7, when the molar ratio of lithium to aluminum, Li:Al, is within the range of 30:70 to 80:20, it is difficult for an α-LiAl phase, in which aluminum is excessive, or a lithium monophase, to form in the aluminum-lithium alloy. In particular, within the molar ratio, Li:Al, of 35:65 to 50:50, a β-LiAl phase in which the molar ratio of lithium to aluminum is approximately 1:1 is easily formed in the aluminum-lithium alloy.

From the results of the cycle tests of Example 5 and Example 6 shown in FIG. 6, within the molar ratio of lithium to aluminum, Li:Al, of 30:70 to 80:20, a declining tendency in discharging capacity retention rates is recognized up to about 10 cycles. However, even when the charge and discharge is further repeated, an α-LiAl phase or a lithium monophase is not easily formed in the aluminum-lithium alloy. An aluminum-lithium alloy layer having an appropriate blending ratio is considered to keep on growing by repeating the charge and discharge process.

Therefore, within the molar ratio, Li:Al, of 30:70 to 80:20, it is possible to provide a solid-state battery in which discharging capacity does not easily decline even if charge and discharge are repeated.

Furthermore, from the results of the cycle tests of Example 2 to Example 4 shown in FIG. 6, within the molar ratio of lithium to aluminum, Li:Al, of 35:65 to 50:50, as charge and discharge is repeated, a β-LiAl phase is formed in the aluminum-lithium alloy, and an aluminum-lithium alloy layer with an appropriate blending ratio is considered to keep on growing.

Therefore, it is considered that, within the molar ratio of Li:Al of 35:65 to 50:50, it is possible to provide a solid-state battery in which discharging capacity does not easily decline, even after repeated charging and discharging.

### Example 7

On an electrode obtained by coating an aluminum plate with a solid electrolyte layer in advance, an electrode coated with a cathode layer was superposed and pressure molded at a pressure of 4.5 ton/cm2 in a uniaxial press.

Thereafter, a lithium plate was placed under an anode electrode layer and pressure molded at a pressure of 1 ton/cm2 to prepare a solid-state battery.

An aluminum plate having a thickness of 100 μm and a lithium plate having a thickness of 100 μm were used as the anode electrode layer.

### Comparative Example 2

A mixture electrode obtained by mixing hard carbon (anode active material) and a solid electrolyte at a ratio of 55:45 wt % was molded in a uniaxial press under a pressure of 3 ton/cm2.

The anode electrode layer after molding was coated with a solid electrolyte layer.

Thereafter, an electrode coated with a cathode layer was superposed and pressure molded at a pressure of 4.5 ton/cm2 in a uniaxial press to prepare a solid-state battery.

With respect to the solid-state batteries of Example 7 and Comparative Example 2, charge and discharge of 100 cycles was performed at a current density of 1 mA/cm2 and cross-sectional layers of the anode electrodes after the charge and discharge were observed by SEM.

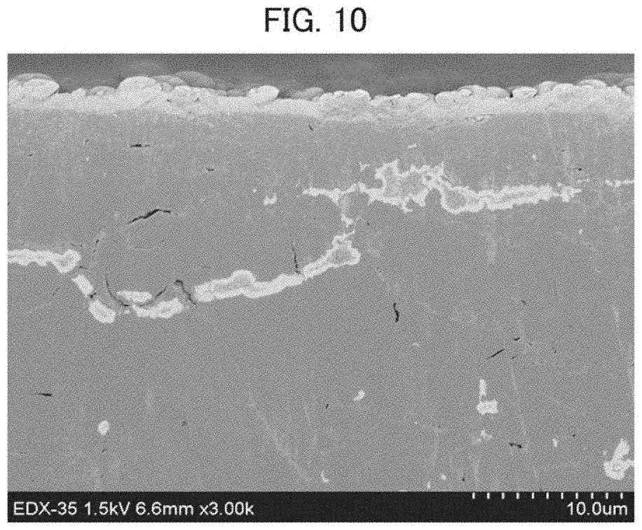

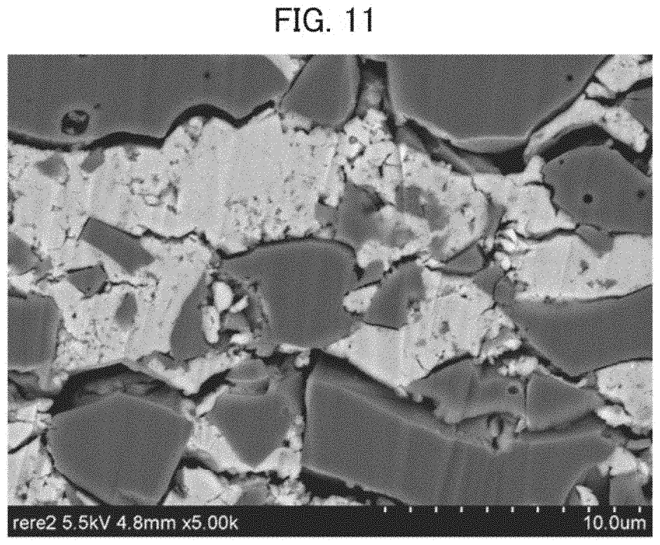

Observation photographs are shown in FIGS. 10 and 11.

As shown in FIGS. 10 and 11, the solid-state battery of Example 7 comprising a solid electrolyte material applied on an aluminum plate was confirmed to have a good junction interface formed at the interface between the anode electrode layer and the solid electrolyte.

On the other hand, in Comparative Example 2 comprising a mixture electrode prepared from a mixture powder, considerable exfoliation was confirmed at the interface between the anode active material and the solid electrolyte.

Specifically, as shown in FIG. 10, no exfoliation occurred between the anode electrode layer (aluminum plate) and the solid electrolyte of Example 7, and it was confirmed that a good junction interface was formed at the interface between the anode electrode layer and the solid electrolyte.

Furthermore, in the anode electrode layer of Example 7, no voids were confirmed between the aluminum plate and the aluminum-lithium alloy layer, or between the aluminum-lithium alloy layer and the lithium plate. That is, the anode electrode layer of Example 7 was confirmed to have become a dense electrode layer.

On the other hand, as shown in FIG. 11, exfoliation was confirmed at the interface between the anode electrode layer (anode active material) of Example 7 and the solid electrolyte. Further, in the anode electrode layer of Comparative Example 2, numerous voids were also confirmed at the interface between the anode active material and the solid electrolyte. That is, the anode electrode layer of Comparative Example 2 was confirmed to be not densified as an electrode layer.

Therefore, the manufacturing method of Example 7 could perform interfacial junction between the solid electrolyte and the anode active material by a relatively lower battery restricting pressure than the manufacturing method of Comparative Example 2, and could provide a low-resistance and highly durable solid-state battery.

### EXPLANATION OF REFERENCE NUMERALS

1 Solid-state battery

20 Cathode electrode layer

30 Anode electrode layer

31 Aluminum layer

32 Lithium layer

33 Aluminum-lithium alloy layer

40 Solid electrolyte layer

1. A solid-state battery comprising a cathode electrode layer, an anode electrode layer and a solid electrolyte layer disposed between the cathode electrode layer and the anode electrode layer,
wherein the anode electrode layer comprises an aluminum layer in contact with the solid electrolyte layer, a lithium layer and an aluminum-lithium alloy layer disposed between the aluminum layer and the lithium layer.

2. The solid-state battery according to claim 1, wherein a film thickness of the anode electrode layer is 10 to 400 μm.

3. The solid-state battery according to claim 1, wherein a molar ratio of lithium to aluminum, Li:Al, in the anode electrode layer is 30:70 to 80:20.

4. The solid-state battery according to claim 1, wherein the solid electrolyte layer is a sulfide-based solid electrolyte material.

5. A method for manufacturing a solid-state battery comprising a cathode electrode layer, an anode electrode layer comprising an aluminum layer and a lithium layer, and a solid electrolyte layer disposed between the cathode electrode layer and the anode electrode layer,
the method comprising: a step of applying a solid electrolyte material to an aluminum plate for forming the aluminum layer to form the solid electrolyte layer; and
a step of press joining a laminate to obtain the solid-state battery, with the laminate being obtained by disposing the cathode electrode layer on the solid electrolyte layer formed on one surface of the aluminum plate, and, disposing a lithium plate for forming the lithium layer on the other surface of the aluminum plate on which the solid electrolyte layer is not formed.

6. The method for manufacturing a solid-state battery according to claim 5, wherein the method further comprises a step of cutting the press joined solid-state battery to a predetermined length under compression.

7. The method for manufacturing a solid-state battery according to claim 5, wherein the press joining is performed by a roll pressing method.

8. The solid-state battery according to claim 1,
wherein a film thickness of the anode electrode layer is 10 to 400 μm,
wherein a molar ratio of lithium to aluminum, Li:Al, in the anode electrode layer is 30:70 to 80:20.

9. The solid-state battery according to claim 1,
wherein a film thickness of the anode electrode layer is 10 to 400 μm,
wherein the solid electrolyte layer is a sulfide-based solid electrolyte material.

10. The solid-state battery according to claim 1. wherein a molar ratio of lithium to aluminum, Li:Al, in the anode electrode layer is 30:70 to 80:20,
wherein the solid electrolyte layer is a sulfide-based solid electrolyte material.

11. The solid-state battery according to claim 1,
wherein a film thickness of the anode electrode layer is 10 to 400 μm,
wherein a molar ratio of lithium to aluminum, Li:Al, in the anode electrode layer is 30:70 to 80:20,
wherein the solid electrolyte layer is a sulfide-based solid electrolyte material.

12. The method for manufacturing a solid-state battery according to claim 5,
wherein the method further comprises a step of cutting the press joined solid-state battery to a predetermined length under compression, wherein the press joining is performed by a roll pressing method.
